(19) United States
(12) Patent Application Publication
(10) Pub. No.: US 2021/0117389 A1
(43) Pub. Date: Apr. 22, 2021

(54) NETWORK TRAFFIC OPTIMIZATION USING DEDUPLICATION INFORMATION FROM A STORAGE SYSTEM

(71) Applicant: VMware, Inc., Palo Alto, CA (US)

(72) Inventors: Liang Cui, Beijing (CN); Siddharth Sudhir Ekbote, San Jose, CA (US)

(21) Appl. No.: 16/657,837

(22) Filed: Oct. 18, 2019

(51) Int. Cl. G06F 16/174; G06F 3/06; G06F 16/13

(52) U.S. Cl. CPC G06F 16/1752; G06F 3/0641; G06F 3/0608; G06F 16/137; G06F 3/0665; G06F 3/067

(57) ABSTRACT

The technology disclosed herein enables optimization of network traffic by deduplicating data for transmission using deduplication information generated by a storage system from which the data is being transferred. In a particular embodiment, a method provides, in a network traffic optimizer, receiving first data from a first storage system for transmission over the communication network. The first storage system performed a deduplication process on the first data when storing the first data therein and the deduplication process generated first deduplication information for the first data. The method further provides deduplicating the first data using the first deduplication information in the first storage system and transmitting the first data over the communication network.

### TECHNICAL BACKGROUND

Network traffic optimizers are used to transfer data over networks with more efficiency. Various optimization techniques can be used by a network traffic optimizer to increase the speed in which data is transferred over a network and reduce the amount of bandwidth used to transfer that data. While network traffic optimizers can be used when transferring data over any type of network, data transfers over wide area networks (WANs), such as the Internet, stand to benefit even more from network traffic optimization than transfers over local networks since WANs typically have more potential bandwidth restrictions and possibly higher monetary cost for the bandwidth used. Thus, optimizing the data being transferred by reducing the size/amount of the data, should speed up the transfer of the data over networks having limited bandwidth, which may also help reduce any monetary cost associated with the transfer.

Deduplication is one manner in which data size can be reduced when storing data. Deduplication identifies one or more portions of data that are identical to a portion of data already stored (i.e., are duplicates). Rather than storing multiple portions of data, only one of the identical portions is stored and is referenced to represent all of the multiple identical portions. Deduplication can also be used when transferring data. Rather than transferring identical portions of the data multiple times, only one of the identical data portions is transferred and only a reference to the transferred identical portion is sent for further instances of the identical portion. While deduplication reduces the amount of data stored and transferred in the above examples, the deduplication process still uses processing resources for identifying duplicates and storage space for storing information about the identified duplicates.

### SUMMARY

The technology disclosed herein enables optimization of network traffic by deduplicating data for transmission using deduplication information generated by a storage system from which the data is being transferred. In a particular embodiment, a method provides, in a network traffic optimizer, receiving first data from a first storage system for transmission over the communication network. The first storage system performed a deduplication process on the first data when storing the first data therein and the deduplication process generated first deduplication information for the first data. The method further provides deduplicating the first data using the first deduplication information in the first storage system and transmitting the first data over the communication network.

In some embodiments, the method provides, in a second network traffic optimizer, receiving the first data over the communication network and restoring the first data using second deduplication information in a second storage system. The method also provides transferring the first data to the second storage system. The second storage system performs the deduplication process on the first data when storing the first data therein and the deduplication process generates the second deduplication information for the first data.

### BRIEF DESCRIPTION OF THE DRAWINGS

FIG. 1 illustrates an implementation for optimizing network traffic using deduplication information from a storage system.

FIG. 2 illustrates an operation to optimize network traffic using deduplication information from a storage system.

FIG. 3 illustrates another operation to optimize network traffic using deduplication information from a storage system.

FIG. 4 illustrates another implementation for optimizing network traffic using deduplication information from a storage system.

FIG. 5 illustrates an operational scenario for optimizing network traffic using deduplication information from a storage system.

FIG. 6 illustrates another operational scenario for optimizing network traffic using deduplication information from a storage system.

FIG. 7 illustrates yet another operational scenario for optimizing network traffic using deduplication information from a storage system.

### DETAILED DESCRIPTION

Deduplication uses processing and storage resources to identify duplicate data portions and store information about the identified duplicate data portions. In some computing environments, data is deduplicated for both storage and for transfer over a communication network. When the data is deduplicated for storage, the storage system performing the deduplication process identifies duplicate portions of the data and stores information about those duplicates in the storage system so that only one copy of the data portion need be stored. The information about the duplicates allows the duplicates of a data portion to be restored from the data portion that is actually stored by the storage system. If that stored data is transferred over a communication network, a network traffic optimizer identifies duplicate portions of the data and stores information about those duplicates, similar to the information stored by the storage system, so that only one copy of the data portion need be transferred.

Since both the storage system and the network traffic optimizer are performing their own deduplication process, the processing resources used to identify duplicates in data and the storage space used for the information about those duplicates is duplicated between the storage system and the network traffic optimizer, which is inefficient. The network traffic optimizers described below do not perform the full deduplication process when deduplicating data to be transferred. Rather, since the data being transferred via one of the network traffic optimizers was stored in a storage system, the network traffic optimizers leverage at least the deduplication information that was already generated for data by the storage system. Resources are, therefore, used more efficiently by not re-performing tasks (e.g., generating and storing deduplication information) that have already been performed.

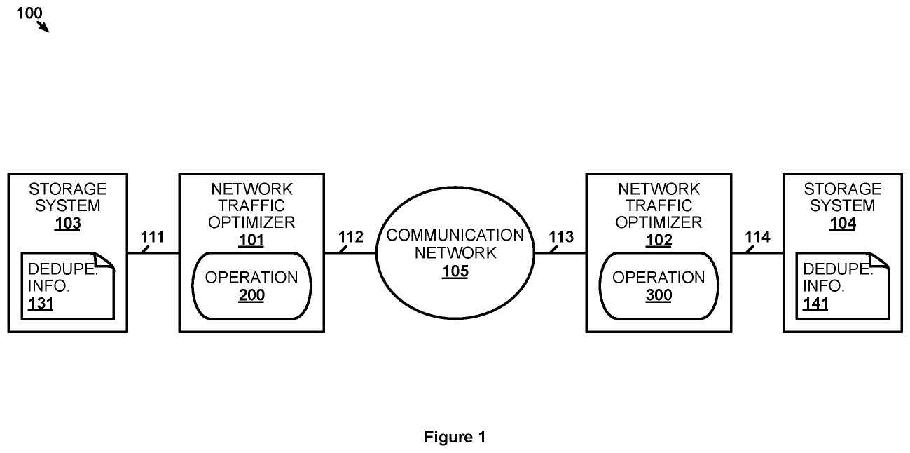

FIG. 1 illustrates implementation 100 for optimizing network traffic using deduplication information from a storage system. Implementation 100 includes network traffic optimizer 101, network traffic optimizer 102, storage system 103, storage system 104, and communication network 105. Respective logical communication links 111-114 connect network traffic optimizer 101, network traffic optimizer 102, storage system 103, storage system 104, and communication network 105. Storage system 103 and network traffic optimizer 101 are local to one another and may be co-located on a computing device (e.g., server). Storage system 104 and network traffic optimizer 102 are similarly local to one another and may be co-located on a computing device (e.g., server). Communication network 105 is a communication network configured to transport data communications between network traffic optimizer 101 and network traffic optimizer 102. While it is possible that network traffic optimizer 101 and network traffic optimizer 102 are local to one another with communication network 105 being only a local network, network traffic optimizer 101 and network traffic optimizer 102 being at different geographical locations (e.g., different cities) would likely benefit more from the network traffic optimization functionality. When network traffic optimizer 101 and network traffic optimizer 102 are at different locations, it is likely that communication network 105 will include at least a portion of a wide area network over which network traffic there between will travel.

In operation, network traffic optimizer 101 receives data that is read from storage system 103, optimizes the data for transfer over communication network 105, and transfers the optimized data to network traffic optimizer 102. In this example, network traffic optimizer 101 at least performs operation 200 to deduplicate the data as part of the network traffic optimization process. While not discussed in detail, network traffic optimizer 101 may also perform other data optimization functions, protocol level optimization functions (e.g., traffic shaping, egress optimization, etc.), and/or transport level optimization functions (e.g., forward error correction). Upon receipt of the network traffic carrying the data from network traffic optimizer 101, network traffic optimizer 102 reverses the data optimization processes performed by network traffic optimizer 101, as needed, to restore the data in preparation for storage and then passes the data to storage system 104 for storage thereon. In those examples, network traffic optimizer 102 at least performs operation 300 on the deduplicated data to the state of the data before deduplication. In other examples, network traffic optimizer 102 may also have to handle other data level, protocol level, and/or transport level optimizations performed on the network traffic or the data therein.

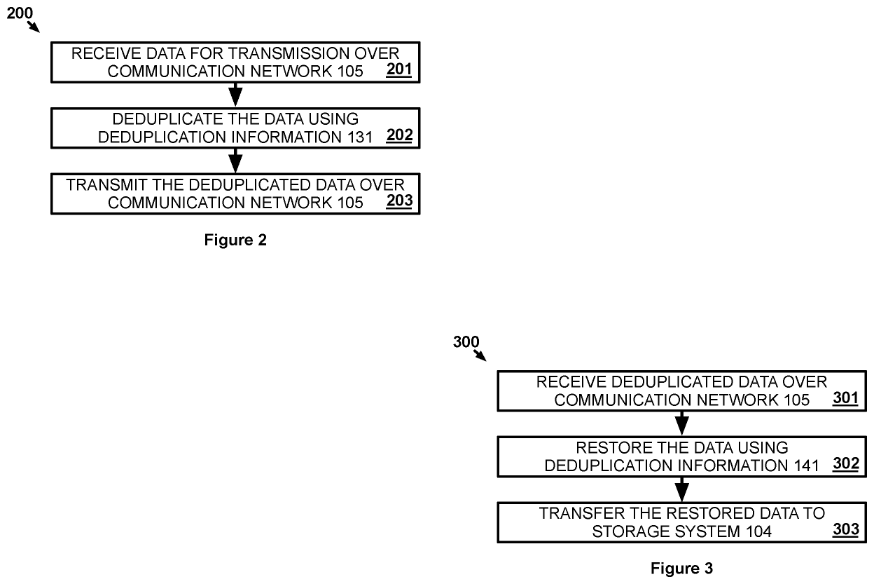

FIG. 2 illustrates operation 200 to optimize network traffic using deduplication information from a storage system. During operation 200, network traffic optimizer 101 receives data from storage system 103 for transmission over communication network 105 (201). The data may be retrieved by network traffic optimizer 101 directly or may be received through some other data handler(s). In an example of the latter, a data selector may be tasked with determining, either on its own or as directed by a user, what data stored on storage system 103 should be transferred over communication network 105. The data selector would retrieve the data from storage system 103 and pass the data to network traffic optimizer 101, or the data selector may direct network traffic optimizer 101 to retrieve the data from storage system 103.

In this example, storage system 103 at least performed a deduplication process on the data when storage system 103 stored the data therein. The deduplication process generated deduplication information 131 for the data. Deduplication information 131 may also include deduplication information for other data that was deduplicated when stored on storage system 103. Deduplication information 131 includes information indicating which portions of the data are duplicates. The manner in which deduplication information 131 indicates the duplicate portions of the data may differ depending on the deduplication scheme used. In one example, deduplication information 131 compiles hashes of data portions that are duplicates and indicates where in the data the duplicate data portions exists (i.e., so the original duplicate data portion can be replaced therein when retrieved). Storage system 103 (and, likewise, storage system 104) may be any type of storage system capable of performing a deduplication process that generates deduplication information 131. For example, storage system 103 may be an individual drive (e.g., hard disk, solid state drive, etc.), may be a processing system controlling one or more drives, may be a network attached storage system, may be a storage area network, may be a virtualized storage area network (or other type of virtualized storage system), or may be some other type of storage system having the processing capability to deduplicate data and generate deduplication information 131.

Since storage system 103 has already created deduplication information 131, network traffic optimizer 101 uses deduplication information 131 to deduplicate the data (202). Network traffic optimizer 101 uses the same deduplication procedure as storage system 103 did when performing deduplication on the data. This allows network traffic optimizer 101 to use deduplication information 131 during the deduplication process. Otherwise, deduplication information 131 would not be relevant to the deduplication process performed by network traffic optimizer 101. In some cases, network traffic optimizer 101 is allowed to access deduplication information 131 directly to determine whether deduplication information 131 indicates that a given chunk is a duplicate. In other cases, network traffic optimizer 101 may query storage system 103 about whether a given chunk is a duplicate, which relies on storage system 103 to reference deduplication information 131 to determine whether the given chunk is a duplicate.

Network traffic optimizer 101 then transmits the data after deduplication over communication network 105 (203). Network traffic optimizer 101 may transmit the data through a direct connection to communication network 105 or may transmit the data through a network access system, such as a communication gateway, to communication network 105. As discussed above, the deduplication process performed by storage system 103 when storing the data therein generates deduplication information 131 to identify deduplicate portions of data (or chunks of data as termed above). Storage system 103 does not re-store the portions that are identified as being duplicates. While network traffic optimizer 101 is transmitting the data rather than storing the data in a storage system, identifying a duplicate portion of the data indicates to network traffic optimizer 101 that network traffic optimizer 101 that the duplicate portion has already been transmitted over communication network 105. Thus, network traffic optimizer 101 need not transmit the duplicate data portion again. Rather, network traffic optimizer 101 may simply transmit an identifier for the duplicate data over communication network 105 (e.g., a placeholder that is smaller in size than the data portion the placeholder is identifying) so that network traffic optimizer 102 can restore the original data portion based on the indicator. In some cases, it is possible that network traffic optimizer 101 erroneously determines a particular portion of the data is a duplicate and does not transmit the portion to network traffic optimizer 102. In those cases, network traffic optimizer 102 and network traffic optimizer 101 may implement a procedure for network traffic optimizer 102 to obtain the actual portion of the data from network traffic optimizer 101 (e.g., network traffic optimizer 102 may request the portion after determining the data portion has not already been received).

Advantageously, network traffic optimizer 101 performs deduplication on the data for transfer without having to generate its own version of deduplication information 131 for the data. Not generating a new version of deduplication information 131 for the data reduces the processing resources used by network traffic optimizer 101 to deduplicate the data and reduces the amount of memory used by network traffic optimizer 101 since a new version of deduplication information 131 for the data need not be stored. Additionally, since the memory available to network traffic optimizer 101 may be limited, it is possible that a version of deduplication information 131 for the data in network traffic optimizer 101 may be less comprehensive than the version of deduplication information 131 generated and stored in storage system 103.

It should be understood that network traffic optimizer 101 need not receive all the data to be transferred before deduplicating the data and transmitting the data over communication network 105. For instance, network traffic optimizer 101 may deduplicate and transmit the data continually as portions of the data are received from storage system 103.

FIG. 3 illustrates operation 300 to optimize network traffic using deduplication information from a storage system. In operation 300, network traffic optimizer 102 receives the deduplicated data transmitted by network traffic optimizer 101 over communication network 105 (301). Network traffic optimizer 102 may receive the data through a direct connection to communication network 105 or may receive the data through a network access system, such as a communication gateway, to communication network 105. In order to restore the data properly, network traffic optimizer 102 is aware of the deduplication scheme used by network traffic optimizer 101 before transmitting the data over communication network 105. For example, network traffic optimizer 101 and network traffic optimizer 102 may be network traffic optimizers from the same vendor or may otherwise be configured to use the same deduplication scheme.

Network traffic optimizer 102 restores the deduplicated data back into its non-deduplicated form using deduplication information 141 generated by storage system 104 (302). In operation 200, storage system 103 had already generated deduplication information 131 for the data before the data was deduplicated by network traffic optimizer 101 because the data was stored on storage system 103 before being received by network traffic optimizer 101. In operation 300, the data has not yet been stored on storage system 104 and, therefore, storage system 104 cannot begin to generate information 141 for the data until storage of the data on storage system 104 begins. As such, deduplication information 141 may not indicate anything is a duplicate until the data begins to be stored therein. Although, deduplication information 141 may already exist for other data that is already stored on storage system 104. If deduplication is performed based on more than just a single data set, such as that being received by network traffic optimizer 102 in this example, then deduplication information 141 may still be relevant to the deduplicated data received by deduplication information 141 even before storage system 104 begins to store that received data.

In this case, network traffic optimizer 102 receives both data chunks that network traffic optimizer 101 determined to not be duplicates and information indicating data chunks that network traffic optimizer 101 determined to be duplicates. When the received information indicates a particular duplicate data chunk, network traffic optimizer 102 may access deduplication information 141 to determine the actual data chunk indicated by the received information. If the actual data chunk exists in storage system 104, either within deduplication information 141 or elsewhere in storage system 104, then network traffic optimizer 102 retrieves the actual data chunk to restore that chunk in the received data. In some cases, network traffic optimizer 102 is allowed to access deduplication information 141 directly to determine the actual data chunk is identified in deduplication information 141. In other cases, network traffic optimizer 102 may query storage system 104 about whether a given chunk is identified in deduplication information 141, which relies on storage system 104 to reference deduplication information 141 to identify the actual data chunk. If, however, the actual data chunk cannot be found in deduplication information 141 (i.e., deduplication information 141 does not indicate the data chunk is a duplicate), then network traffic optimizer 102 implements a procedure for network traffic optimizer 102 to obtain the actual data chunk from network traffic optimizer 101 (e.g., network traffic optimizer 102 may request the portion after determining the data portion has not already been received).

Once the data has been restored from its deduplicated state, network traffic optimizer 102 transfers the data to storage system 104 (303). The data may be transferred directly to storage system 104 or may be transferred through another component, such as the application proxy discussed below. Preferably, to transfer the restored data, network traffic optimizer 102 transfers each complete data chunk as soon as possible (i.e., upon receipt from network traffic optimizer 101, if received intact, or upon restoration) unless there is a reason that network traffic optimizer 102 would need to wait before transferring a particular data chunk (e.g., storage system 104 may not be able to receive chunks out of order, so network traffic optimizer 102 may need to wait until a chunk can be sent in order). Upon receipt of each chunk, storage system 104 deduplicates the data itself to compile deduplication information 141, which can then be used by network traffic optimizer 102 for data chunks still being received from network traffic optimizer 101. Thus, as more data chunks are stored by storage system 104, the more complete deduplication information 141 becomes with respect to the deduplicated data received from network traffic optimizer 101.

In operation 200 and operation 300 above, the network traffic optimizer 101 and network traffic optimizer 102 respectively use deduplication information 131 and deduplication information 141 generated by storage system 103 and storage system 104. Although, in some examples, either network traffic optimizer 101 or network traffic optimizer 102 may perform the deduplication process by generating their own version of deduplication information 131 of deduplication information 141. Since the deduplication scheme remains the same, the network traffic optimizer that does not use deduplication information generated by its associated storage system can still deduplicate or restore the data being transferred in the network traffic between network traffic optimizer 101 and network traffic optimizer 102. That network traffic optimizer, of course, does not receive the benefits provided by using the already generated deduplication information 131 or deduplication information 141.

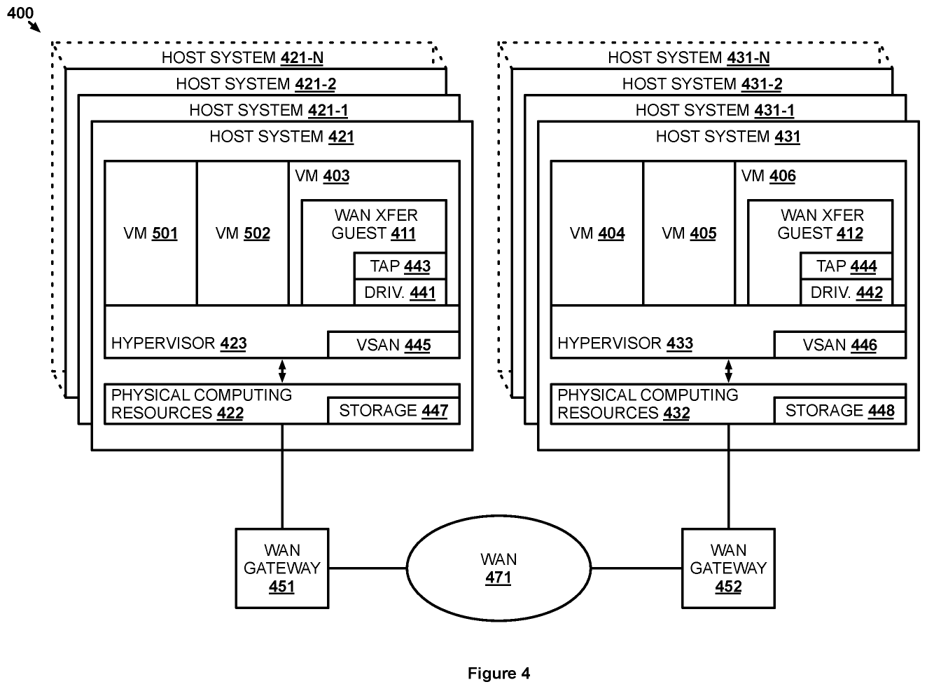

FIG. 4 illustrates implementation 400 for optimizing network traffic using deduplication information from a storage system. In this example, host computing system 421 executes hypervisor 423, as hosts, to allocate physical computing resources 422 among virtual machines 501, 502, and 403. Likewise, host computing system 431 executes hypervisor 433 to allocate physical computing resources 432 among virtual machines 404-406. Physical computing resources 422 and 432 may include processing resources (e.g., processing circuitry, CPU time/cores, etc.), memory space (e.g., random access memory, hard disk drive(s), flash memory, etc.), network interfaces, user interfaces, or any other type of resource that a physical computing system may include. In particular, physical computing resources 422 and hypervisor 433 include storage 447 and storage 448, respectively, which include at least a portion of the storage devices in physical computing resources 422 and hypervisor 433 (e.g., hard drives, solid state drives, etc.). While not shown, each of virtual machines 401-406 may have a respective guest operating system (OS) executing as part of the workload thereon. One or more applications may be running on each of guest OSs to perform various tasks. In other examples, containers, or other types of virtualized process environments, may execute on host computing systems 421 and 431 in place of, or in combination with, the virtual machines described below.

It should be understood that the distribution of virtual machines may be different across host computing systems, as the distribution shown in FIG. 4 is merely exemplary (e.g., any one host computing system may host more or fewer virtual machines than shown). Likewise, the host computing systems could host additional hosts (e.g., hypervisors) and virtual machines and/or other virtual elements that are not involved in this example. Host computing systems 421-1, 421-2, through 421-N and host computing systems 431-1, 431-2, through 431-N all include similar architectures to those described for host computing system 421 and host computing system 431.

In this example, a cluster of virtual machines, which the examples below will refer to as the local cluster, is being executed on one or more host computing systems 421 through 421-N. One of the virtual machines in the cluster, virtual machine 403, includes WAN transfer guest 411. WAN transfer guest 411 is tasked with migrating data for one or more of the other virtual machines, including virtual machine 501 and virtual machine 502, over WAN 471 to one or more of host computing systems 431 through 431-N. Host computing systems 431 through 431-N are executing a cluster of virtual machines that the examples below will refer to as the remote cluster. The data transferred by WAN transfer guest 411 may represent data being processed in the local cluster, may be data representing one or more of the virtual machines in the local cluster, data representing settings for one or more of the virtual machines, or some other type of data that may be stored in virtualized storage area network 445—including combinations thereof. As such, it is possible that virtual machine 501 and virtual machine 502 may be transferred as a whole to the remote cluster and virtual machine 404 and virtual machine 405 may be instances of virtual machine 501 and virtual machine 502 at that remote cluster after transfer. Similar to virtual machine 403, virtual machine 406 in the remote cluster executes WAN transfer guest 412, which is tasked with handling the migration of data at the remote cluster. While the examples below focus on the transfer of data from WAN transfer guest 411 at the local cluster to WAN transfer guest 412 at the remote cluster, the same processes may be performed to transfer data from WAN transfer guest 412 to WAN transfer guest 411.

Hypervisor 423 executes an instance of virtualized storage area network 445. An instance of virtualized storage area network 445 executes in a hypervisor on all of the host computing systems in the local cluster. Virtualized storage area network 445 is configured to represent storage 447 on each respective one of the local cluster's host computing systems as a single storage space for use by the virtual machines in the local cluster, at least those that are allowed access to virtualized storage area network 445. Similarly, hypervisor 433 executes an instance of virtualized storage area network 446. Virtualized storage area network 446 is configured to represent storage 448 on each respective one of the remote cluster's host computing systems as a single storage space for use by the virtual machines in the remote cluster, at least those that are allowed to access virtualized storage area network 446. Virtual machine 403 executes storage driver 441 that provides virtual machine 403 with the capability of accessing data stored in virtualized storage area network 445. Likewise, virtual machine 406 executes storage driver 442 that provides virtual machine 406 with access to virtualized storage area network 446. Though not shown, virtual machine 501 and virtual machine 502 may also execute a similar storage driver to access virtualized storage area network 445 and virtual machine 404 and virtual machine 405 may also execute a similar storage driver to access virtualized storage area network 446.

While storage driver 441 alone allows WAN transfer guest 411 to access data stored in virtualized storage area network 445 on behalf of virtual machines in the local cluster, tap driver 443 is executed on top of storage driver 441 to allow WAN transfer guest 411 to access deduplication information generated by virtualized storage area network 445 when that data is stored therein. Since deduplication of data is typically transparent to the virtual machines, there is usually no reason to provide access to that deduplication information. That deduplication information is used by WAN transfer guest 411 in the examples below (specifically WAN optimizer 512 shown in operational scenario 500) to “tap” into the otherwise inaccessible deduplication information. In particular, a log component operating in the kernel space of virtualized storage area network 445 opens a port in virtualized storage area network 445 to which storage driver 441 can bind to transfer deduplication requests. The log component handles input/output (I/O) operations of data being stored/retrieved from virtualized storage area network 445. In this case, the I/O operations include deduplication of the data but may also include other operations, such as data compression. When storage driver 441 binds to the port in virtualized storage area network 445, rather than WANOP 512 being provided with typical disk access (e.g., as would virtual machine 501), the binding triggers WANOP 512 to load tap driver 443 on top of storage driver 441. WANOP 512 can then use tap driver 443 to exchange deduplication requests/responses with the log component within virtualized storage area network 445.

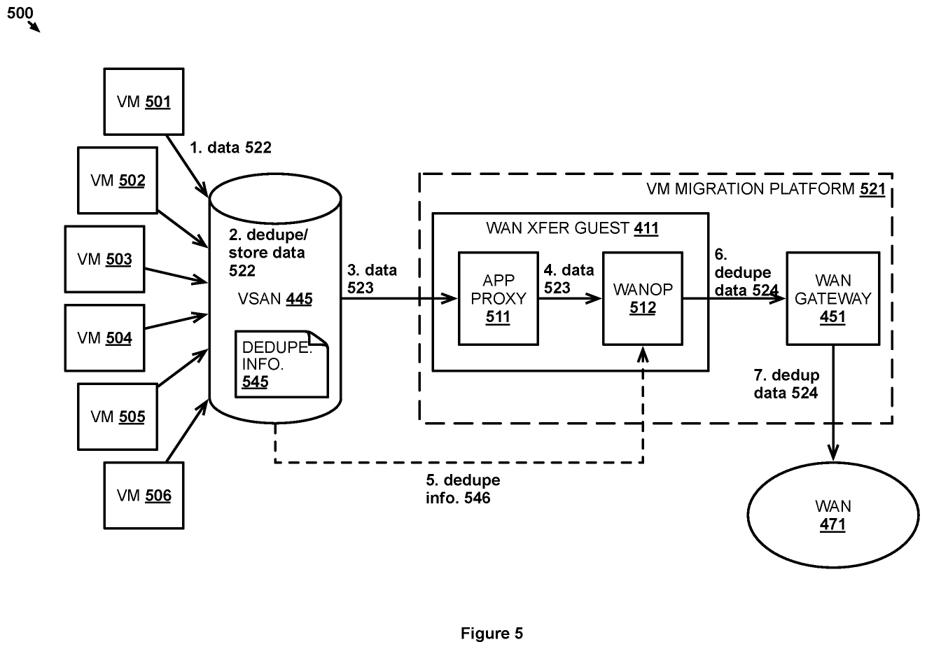

FIG. 5 illustrates operational scenario 500 for optimizing network traffic using deduplication information from a storage system. In operational scenario 500, the local cluster of virtual machines includes virtual machines 503-506 in addition to virtual machines 501-502 on host computing system 421. Virtual machines 503-506 are distributed across one or more of the other host computing systems 421-1 through 421-N. Each of virtual machines 501-506 is able to access virtualized storage area network 445. As described above, virtualized storage area network 445 represents the local storage, such as storage 447, across all the respective host computing systems as a single storage volume to virtual machines 501-506.

In this example, WAN transfer guest 411 and WAN gateway 451 are part of virtual machine migration platform 521. Virtual machine migration platform 521 handles the migration of virtual machines between host computing systems over WAN 471. For instance, virtual machines 501-506 operating in the local cluster may be physically located at a data center of a business. Virtual machine migration platform 521 facilitates the transfer of one or more of virtual machines 501-506 over WAN 471 so that the transferred virtual machines can operate in a remote cluster on host computing systems 431 through 431-N. The remote cluster, for example, may be implemented at a facility operated by a cloud computing provider. A counterpart to virtual machine migration platform 521 comprising WAN transfer guest 412 and WAN gateway 452 operates at the remote cluster to handle the receipt of the transferred virtual machines and, if so directed, the transfer of virtual machines back to the local cluster.

At step 1 of operational scenario 500, data 522 for virtual machines 501-506 is stored on virtualized storage area network 445. Data 522 may include data representing the virtual machines 501-506 themselves (e.g., operating systems, applications, configuration parameters, etc., which may be represented as a virtual machine disk file or other type of file representing a virtual appliance), data being processed by virtual machines 501-506, settings for virtual machines 501-506, or any other data relevant to the operation of virtual machines 501-506—including combinations thereof. Upon receipt of data 522, virtualized storage area network 445 deduplicates data 522 and stores data 522 therein at step 2. The deduplication at step 2 creates deduplication information 545, which is used to reverse the deduplication of data 522 when accessing any portion of data 522.

After data 522 is stored in virtualized storage area network 445, application proxy 511 is instructed to migrate virtual machines 501-506 to the remote cluster over WAN 471. The migration may be a live migration, a storage migration, or some other type of migration depending on what type of migration application proxy 511 is configured to perform. Other examples may migrate fewer of virtual machines 501-506. An administrator user of the local cluster may instruct application proxy 511 to migrate virtual machines 501-506, there may be rules, either internal to application proxy 511 or in a system communicating with application proxy 511, that automatically trigger application proxy 511 to perform the migration when certain conditions are met, or some other manner of instructing application proxy 511 to migrate virtual machines 501-506.

To migrate virtual machines 501-506, application proxy 511 retrieves data 523 from virtualized storage area network 445. Data 523 may include all of data 522 or some portion thereof. For example, the data for an operating system of virtual machines 501-506 may already be located at the remote cluster and that data would, therefore, not need to be sent (i.e., would not be included in data 523). In other examples, the entirety of the data representing a virtual machine, such as the data in a virtual machine disk file, may be sent (i.e., would be included in data 523). Regardless of what portion of data 522 included in data 523, application proxy 511 retrieves data 523 from virtualized storage area network 445 at step 3. Virtualized storage area network 445 provides data 523 in non-deduplicated form to application proxy 511.

Application proxy 511 passes data 523 to WANOP 512 at step 4 so that WANOP 512 can optimize data 523 for transmission over WAN 471. In this example, WANOP 512 deduplicates data 523 as part of its data optimizations although, in other examples, additional data level, protocol level, and/or transport level optimizations may also be performed. As discussed above, WANOP 512 uses tap driver 443 to query virtualized storage area network 445 for deduplication information 545 step 5, which WANOP 512 uses to deduplicate data 523 and create deduplicated data 524. Deduplicated data 524 is passed from WANOP 512 to WAN gateway 451 at step 6 and WAN gateway 451 transfers deduplicated data 524 to the remote cluster over WAN 471 at step 7.

While not shown, deduplicated data 524 is received at the remote cluster through WAN gateway 452 and passed into WAN transfer guest 412 to restore deduplicated data 524 back to data 523. A WANOP within WAN transfer guest 412 restores data 523 from deduplicated data 524 using deduplication information generated by virtualized storage area network 446. Tap driver 444 runs on top of storage driver 442 in order to provide the WANOP with access to the deduplication information in virtualized storage area network 446 in the same way tap driver 443 provided WANOP 512 with access to deduplication information 545.

In some examples, virtual machine migration platform 521 may include more than one WAN transfer guest. Multiple WAN transfer guests allows for data optimization to occur in parallel, which increases throughput. Like WANOP 512, the WANOP in each of the WAN transfer guests all use deduplication information 545 to perform deduplication. The benefits of using deduplication information 545 to perform WANOP deduplication is therefore multiplied when additional WANOPs also do not generate their own deduplication information. The additional WAN transfer guests may use WAN gateway 451 or may communicate with WAN 471 through one or more additional WAN gateways.

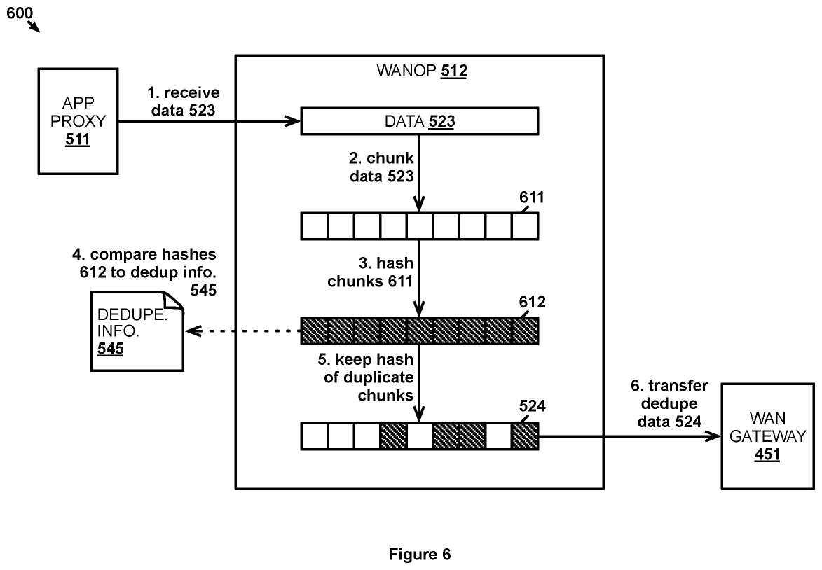

FIG. 6 illustrates operational scenario 600 for optimizing network traffic using deduplication information from a storage system. Operational scenario 600 is a more detailed example of how WANOP 512 may deduplicate data 523 in operational scenario 500. WANOP 512 receives data 523 from application proxy 511 at step 1. As WANOP 512 receives data 523, WANOP 512 chunks the data at step 2 into a plurality of chunks 611. Since data 523 may be a large amount of data, data 523 as illustrated in operational scenario 600 may be only a portion of data 523. For example, chunks 611 may comprise chunks of a portion of data 523 currently buffered in WANOP 512 for optimization before being passed to WAN gateway 451 to make room in the buffer for additional portions of data 523 from application proxy 511. WANOP 512 may also chunk data 523 (and perform the remainder of steps 3-5) continually as portions of data 523 continue to be received from data 523. The parameters WANOP 512 uses to chunk data 523, such as chunk size (e.g., block level), are the same as those used by virtualized storage area network 445 to deduplicate data 523 when data 523 was stored in virtualized storage area network 445 as part of data 522.

WANOP 512 then uses a hash function to hash each of chunks 611 at step 3, which creates hashes 612 for each of chunks 611. In this example, deduplication information 545 includes a hash, possibly organized into a hash table, for each data chunk virtualized storage area network 445 determined to be a duplicate chunk during storage. Deduplication information 545 further references a location in virtualized storage area network 445 where the actual data chunk from which each hash was stored. Since chunks 611 are the same chunks virtualized storage area network 445 would have created to deduplicate data 523 when stored as part of data 522, hashes 612 are also hashes that virtualized storage area network 445 would have created to deduplicate data 523. As such, deduplication information 545 is applicable to hashes 612, which allows WANOP 512 to compare hashes 612 to those in deduplication information 545 at step 4 to determine which of chunks 611 are duplicates of chunks that were already transferred over WAN 471.

To compare hashes 612, WANOP 512 may use tap driver 443 to transfer a request to virtualized storage area network 445 that asks virtualized storage area network 445 to check whether a particular one of hashes 612 are in deduplication information 545 (e.g., may pass the hash with the request). Virtualized storage area network 445 may then respond indicating whether the particular hash is in deduplication information 545 (or otherwise indicate that the hash, or the chunk from which the hash was created, is a duplicate). In some cases, WANOP 512 may request that virtualized storage area network 445 compare hashes in batches rather than the single hash described above.

When virtualized storage area network 445 indicates that a particular hash or hashes 612 corresponds to a duplicate one of chunks 611, WANOP 512 replaces the corresponding chunk in data 523 with the hash. Keeping the hashes corresponding to duplicate chunks at step 5 results in deduplicated data 524. In this example, WANOP 512 replaces four of chunks 611 with corresponding hashes from hashes 612. As with data 523, deduplicated data 524 illustrated in operational scenario 600 may be only a portion of deduplicated data 524 that will be transferred. WANOP 512 transfers deduplicated data 524 to WAN gateway 451 at step 6 so that WAN gateway 451 can transfer deduplicated data 524 over WAN 471.

While WANOP 512 is shown as chunking and hashing data 523 itself in steps 2 and 3 above, WANOP 512 may pass portions of data 523 back to virtualized storage area network 445 to chunk, hash, and compare hashes 612 to deduplication information 545. For instance, when a data buffer of WANOP 512 is filled, or otherwise reaches a threshold fill level, the contents of the buffer may be passed to virtualized storage area network 445 using tap driver 443 along with a request for virtualized storage area network 445 to deduplicate the contents. With respect to operational scenario 600, data 523 may be the contents of the buffer that is passed to virtualized storage area network 445 and virtualized storage area network 445 returns deduplicated data 524 after deduplication. In such examples, WANOP 512 effectively relies on virtualized storage area network 445 to perform the deduplication optimization using deduplication information 545. Since an instance of virtualized storage area network 445 is running on host computing system 421 along with WANOP 512, the overhead added by passing the buffer contents back to virtualized storage area network 445 should be negligible.

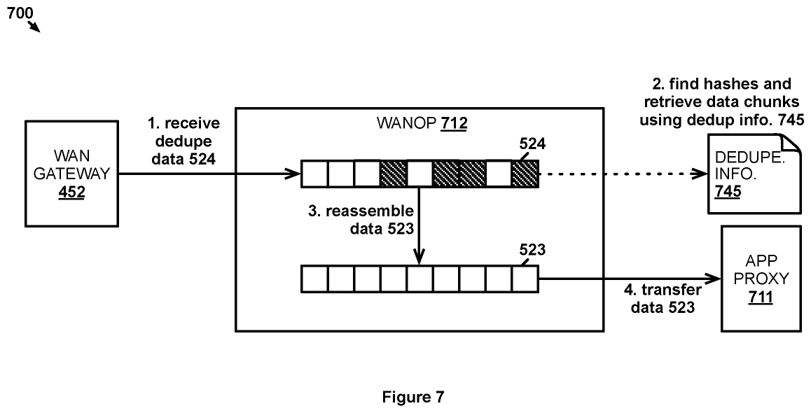

FIG. 7 illustrates operational scenario 700 for optimizing network traffic using deduplication information from a storage system. Operational scenario 700 is an example of how WAN transfer guest 412 may handle receiving deduplicated data 524 transferred in operational scenario 600. After receiving deduplicated data 524 over WAN 471, WAN gateway 452 passes deduplicated data 524 to WANOP 712, which is the WANOP in WAN transfer guest 412 like WANOP 512 is the WANOP in WAN transfer guest 411. WANOP 712 identifies the hashes from within deduplicated data 524 and uses tap driver 444 to request the data chunks corresponding to the respective hashes from virtualized storage area network 446. WANOP 712 may transfer a separate request for each respective hash or may request the data chunks for multiple hashes at once. Virtualized storage area network 446 finds the requested hashes in deduplication information 745 and returns the corresponding data chunks to WANOP 712. Deduplication information 745 is generated by virtualized storage area network 446 as virtualized storage area network 446 deduplicates and stores data therein, such as earlier received portions of data 523, just like virtualized storage area network 445 generated deduplication information 545 when deduplicating and storing data 522. If a hash cannot be found in deduplication information 745, WANOP 712 may transfer a request for the corresponding chunk to WANOP 512 or may perform some other method for retrieving the missing chunk.

As WANOP 712 receives a chunk corresponding to a hash received in deduplicated data 524, WANOP 712 reassembles data 523 at step 3 by replacing the hash in deduplicated data 524 with the corresponding chunk. WANOP 712 then transfers data 523 to application proxy 711 at step 4. Application proxy 711 may then direct virtualized storage area network 446 to store data 523 and perform any other function necessary to complete the migration of virtual machines 501-506 to the remote cluster once all of data 523 has been received over WAN 471.

In some examples, WANOP 712 may buffer deduplicated data 524 and pass the contents of the buffer to virtualized storage area network 446 and rely on virtualized storage area network 446 to restore the contents of the buffer using deduplication information 745. Virtualized storage area network 446 would then return data 523 to WANOP 712. As such, like WANOP 512 may use virtualized storage area network 445 for deduplication, WANOP 712 uses virtualized storage area network 446 for restoration in this example.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method of leveraging storage deduplication when transferring data over a communication network, the method comprising:
in a network traffic optimizer:
receiving first data from a first storage system for transmission over the communication network, wherein the first storage system performed a deduplication process on the first data when storing the first data therein and wherein the deduplication process generated first deduplication information for the first data;
deduplicating the first data using the first deduplication information in the first storage system; and
transmitting the first data over the communication network.

2. The method of claim 1, wherein deduplicating the first data comprises:
buffering the first data in a buffer;
chunking contents of the buffer into first data chunks; and
referencing the first deduplication information in the first storage system to identify duplicate data chunks of the first data chunks.

3. The method of claim 2, wherein the first deduplication information includes a hash table, and wherein deduplicating the first data further comprises:
computing a hash for each data chunk of the data chunks; and
determining whether the hash for each data chunk is in the hash table, wherein the hash for a data chunk of the data chunks being in the hash table indicates that the data chunk is a duplicate.

4. The method of claim 3, wherein transmitting the first data over the communication network comprises:
transmitting chunks of the first data chunks that are not determined to be duplicates; and
transmitting hashes for chunks of the first data chunks that are determined to be duplicates.

5. The method of claim 1, wherein deduplicating the first data comprises:
buffering the first data in a buffer;
passing contents of the buffer to the first storage system, wherein the first storage system chunks the contents into first data chunks and determines which of the first data chunks are duplicates; and
receiving, from the first storage system, an indication of which of the first data chunks are duplicates.

6. The method of claim 5, wherein the indication includes a hash for each chunk of the first data chunks that is determined to be a duplicate.

7. The method of claim 1, wherein the first storage system comprises a virtualized storage area network spanning a plurality of host computing systems.

8. The method of claim 7, wherein deduplicating the first data comprises:
executing a tap driver on top of a disk driver for the virtualized storage area network in the network traffic optimizer; and
transferring one or more deduplication requests using the tap driver to a deduplication port of the virtualized storage area network.

9. The method of claim 1, wherein the network traffic optimizer comprises one of multiple network traffic optimizers that use the first deduplication information in the first storage system.

10. The method of claim 1, further comprising:
in a second network traffic optimizer:
receiving the first data over the communication network;
restoring the first data using second deduplication information in a second storage system; and
transfer the first data to the second storage system, wherein the second storage system performs the deduplication process on the first data when storing the first data therein and wherein the deduplication process generates the second deduplication information for the first data.

11. A method of leveraging storage deduplication when receiving data over a communication network, the method comprising:
in a network traffic optimizer:
receiving first data over the communication network, wherein the first data has been deduplicated;
restoring the first data using first deduplication information in a first storage system; and
transferring the first data to the first storage system, wherein the first storage system performs a deduplication process on the first data when storing the first data therein and wherein the deduplication process generates the first deduplication information for the first data.

12. The method of claim 11, wherein restoring the first data comprises:
buffering the first data in a buffer, wherein the first data identifies duplicate data chunks of the first data that are duplicates of other data chunks; and
referencing the first deduplication information in the first storage system to retrieve the duplicate data chunks.

13. The method of claim 12, wherein the first deduplication information includes a hash table, wherein hashes corresponding to the respective duplicate data chunks are included in the first data, and wherein restoring the first data further comprises:
identifying the duplicate data chunks corresponding to the respective hashes in the hash table.

14. The method of claim 11, wherein restoring the first data comprises:
buffering the first data in a buffer;
passing contents of the buffer to the first storage system, wherein the first storage system restores duplicate data chunks into the contents; and
receiving, from the first storage system, the contents after restoration.

15. The method of claim 11, wherein the first storage system comprises a virtualized storage area network spanning a plurality of host computing systems.

16. The method of claim 15, wherein restoring the first data comprises:
executing a tap driver on top of a disk driver for the virtualized storage area network in the network traffic optimizer; and
transferring one or more restoration requests using the tap driver to a deduplication port of the virtualized storage area network.

17. The method of claim 11, wherein the network traffic optimizer comprises one of multiple network traffic optimizers that use the first deduplication information in the first storage system.

18. The method of claim 11, further comprising:
in a second network traffic optimizer:
receiving the first data from a second storage system for transmission over the communication network, wherein the second storage system performed the deduplication process on the first data when storing the first data therein and wherein the deduplication process generated second deduplication information for the first data;
deduplicating the first data using the second deduplication information in the second storage system; and
transmitting the first data over the communication network.

19. A apparatus for leveraging storage deduplication when transferring data over a communication network, the apparatus comprising:
one or more computer readable storage media;
a processing system operatively coupled with the one or more computer readable storage media; and
program instructions stored on the one or more computer readable storage media for a network traffic optimizer that, when read and executed by the processing system, direct the processing system to:
receive first data from a first storage system for transmission over the communication network, wherein the first storage system performed a deduplication process on the first data when storing the first data therein and wherein the deduplication process generated first deduplication information for the first data;
deduplicate the first data using the first deduplication information in the first storage system; and
transmit the first data over the communication network.

20. The apparatus of claim 19, wherein to deduplicate the first data, the program instructions direct the processing system to:
buffer the first data in a buffer;
chunk contents of the buffer into first data chunks; and
reference the first deduplication information in the first storage system to identify duplicate data chunks of the first data chunks.

21. The apparatus of claim 20, wherein the first deduplication information includes a hash table, and wherein to deduplicate the first data, the program instructions further direct the processing system to:
compute a hash for each data chunk of the data chunks; and
determine whether the hash for each data chunk is in the hash table, wherein the hash for a data chunk of the data chunks being in the hash table indicates that the data chunk is a duplicate.

22. The apparatus of claim 21, wherein to transmit the first data over the communication network, the program instructions direct the processing system to:
transmit chunks of the first data chunks that are not determined to be duplicates; and
transmit hashes for chunks of the first data chunks that are determined to be duplicates.

23. The apparatus of claim 19, wherein to deduplicate the first data, the program instructions direct the processing system to:
buffer the first data in a buffer;
pass contents of the buffer to the first storage system, wherein the first storage system chunks the contents into first data chunks and determines which of the first data chunks are duplicates; and
receive, from the first storage system, an indication of which of the first data chunks are duplicates.

24. The apparatus of claim 23, wherein the indication includes a hash for each chunk of the first data chunks that is determined to be a duplicate.

25. The apparatus of claim 19, wherein the first storage system comprises a virtualized storage area network spanning a plurality of host computing systems.

26. The apparatus of claim 25, wherein to deduplicate the first data, the program instructions direct the processing system to:
execute a tap driver on top of a disk driver for the virtualized storage area network in the network traffic optimizer; and
transfer one or more deduplication requests using the tap driver to a deduplication port of the virtualized storage area network.

27. The apparatus of claim 19, wherein the network traffic optimizer comprises one of multiple network traffic optimizers that use the first deduplication information in the first storage system.

28. A apparatus for leveraging storage deduplication when receiving data over a communication network, the apparatus comprising:
one or more computer readable storage media;
a processing system operatively coupled with the one or more computer readable storage media; and
program instructions stored on the one or more computer readable storage media for a network traffic optimizer that, when read and executed by the processing system, direct the processing system to:
receive first data over the communication network, wherein the first data has been deduplicated;
restore the first data using first deduplication information in a first storage system; and
transfer the first data to the first storage system, wherein the first storage system performs a deduplication process on the first data when storing the first data therein and wherein the deduplication process generates the first deduplication information for the first data.

29. The apparatus of claim 28, wherein to restore the first data, the program instructions direct the processing system to:
buffer the first data in a buffer, wherein the first data identifies duplicate data chunks of the first data that are duplicates of other data chunks; and
reference the first deduplication information in the first storage system to retrieve the duplicate data chunks.

30. The apparatus of claim 29, wherein the first deduplication information includes a hash table, wherein hashes corresponding to the respective duplicate data chunks are included in the first data, and wherein to restore the first data, the program instructions further direct the processing system to:
identify the duplicate data chunks corresponding to the respective hashes in the hash table.

31. The apparatus of claim 28, wherein to restore the first data, the program instructions direct the processing system to:
buffer the first data in a buffer;
pass contents of the buffer to the first storage system, wherein the first storage system restores duplicate data chunks into the contents; and
receive, from the first storage system, the contents after restoration.

32. The apparatus of claim 28, wherein the first storage system comprises a virtualized storage area network spanning a plurality of host computing systems.

33. The apparatus of claim 32, wherein to restore the first data, the program instructions direct the processing system to:
execute a tap driver on top of a disk driver for the virtualized storage area network in the network traffic optimizer; and
transfer one or more restoration requests using the tap driver to a deduplication port of the virtualized storage area network.

34. The apparatus of claim 28, wherein the network traffic optimizer comprises one of multiple network traffic optimizers that use the first deduplication information in the first storage system.
